(19) United States
(12) Patent Application Publication
(10) Pub. No.: US 2025/0183732 A1
(43) Pub. Date: Jun. 5, 2025

(54) Efficiency Reporting in Wireless Charging Systems

(71) Applicant: Apple Inc., Cupertino, CA (US)

(72) Inventors: Zaid A AbuKhalaf, Sunnyvale, CA (US); Alin I. Gherghescu, Campbell, CA (US); Daniel Ye, San Francisco, CA (US); Srinivasa V. Thirumalai Ananthan Pillai, Santa Clara, CA (US)

(21) Appl. No.: 18/951,085

(22) Filed: Nov. 18, 2024

Related U.S. Application Data
(60) Provisional application No. 63/554,073, filed on Feb. 15, 2024.
(60) Provisional application No. 63/605,396, filed on Dec. 1, 2023.

(51) Int. Cl. H02J 50/80; H02J 50/12

(52) U.S. Cl. CPC H02J 50/80; H02J 50/12

(57) ABSTRACT

A wireless charging system may include a wireless power receiving device that receives wireless power signals from a wireless power transmitting device. The wireless power transmitting device may transmit efficiency information to the wireless power receiving device. The wireless power receiving device may update a wireless power delivery parameter based on the received efficiency information.

This application claims the benefit of U.S. provisional patent application No. 63/605,396, filed Dec. 1, 2023, and U.S. provisional patent application No. 63/554,073, filed Feb. 15, 2024, which are hereby incorporated by reference herein in their entireties.

### FIELD

This relates generally to power systems and, more particularly, to wireless power systems for charging electronic devices.

### BACKGROUND

In a wireless charging system, a wireless power transmitting device transmits wireless power to a wireless power receiving device. The wireless power receiving device charges a battery and/or powers components using the wireless power. The efficiency of the wireless charging system may vary depending on various conditions within the wireless charging system.

### SUMMARY

A system may include a wireless power transmitting device and a wireless power receiving device. The wireless power transmitting device may comprise a first wireless power transfer coil configured to transmit wireless power signals and first control circuitry configured to receive a first packet and, in accordance with receiving the first packet, transmit a second packet that comprises efficiency information. The wireless power receiving device may comprise a second wireless power transfer coil configured to receive the wireless power signals from the first wireless power transfer coil and second control circuitry configured to transmit the first packet, receive the second packet after transmitting the first packet, and, in accordance with receiving the second packet, update a wireless power transfer parameter.

### BRIEF DESCRIPTION OF THE DRAWINGS

FIG. 1 is a schematic diagram of an illustrative wireless power system in accordance with some embodiments.

FIG. 2 is a circuit diagram of wireless power transmitting and receiving circuitry in accordance with some embodiments.

FIG. 3 is a side view of an illustrative wireless power transmitting device such as a wireless charging puck connected to a connector plug via a cable in accordance with some embodiments.

FIG. 4 is a diagram of an illustrative wireless power system showing different power levels at different locations within the system in accordance with some embodiments.

FIG. 5 is a diagram showing how a wireless power transmitting device may transmit efficiency information to a wireless power receiving device in accordance with some embodiments.

FIG. 6 is a diagram of an illustrative packet that includes efficiency information and foreign object detection (FOD) status information in accordance with some embodiments.

FIG. 7 is a flowchart of an illustrative method that may be performed by a wireless power receiving device in accordance with some embodiments.

FIG. 8 is a flowchart of an illustrative method that may be performed by a wireless power transmitting device in accordance with some embodiments.

### DETAILED DESCRIPTION

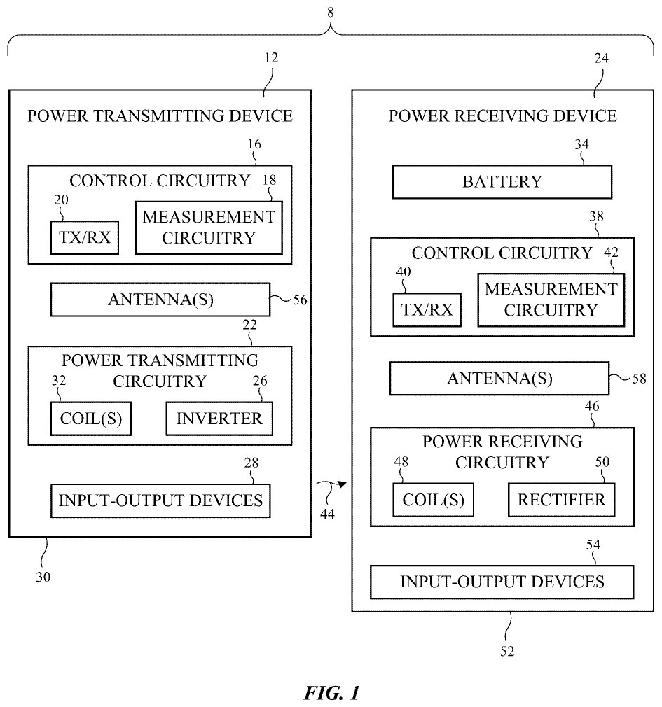

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be referred to herein as wireless power transfer (WPT) system 8 or wireless power system 8. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing 52 for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct-current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transmitting coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any desired frequency (e.g., 100-400 kHz, 1-100 MHz, between 1.7 MHz and 1.8 MHz, less than 2 MHz, between 100 kHz and 2 MHz, etc.). Rectifier circuitry such as rectifier circuitry 50, which contains rectifying components such as synchronous rectification transistors arranged in a bridge network, converts received AC signals (received alternating-current signals associated with wireless power signals 44) from one or more coils 48 into DC voltage signals for powering PRX device 24. Wireless power signals 44 are sometimes referred to herein as wireless power 44 or wireless charging signals 44. Coils 32 are sometimes referred to herein as wireless power transfer coils 32, wireless charging coils 32, or wireless power transmitting coils 32. Coils 48 are sometimes referred to herein as wireless power transfer coils 48, wireless charging coils 48, or wireless power receiving coils 48.

The DC voltage produced by rectifier circuitry 50 (sometime referred to as rectifier output voltage V_{rect}) may be used in charging a battery such as battery 34 and may be used in powering other components in PRX device 24 such as control circuitry 38, input-output (I/O) devices 54, etc. PTX device 12 may also include input-output devices such as input-output devices 28. Input-output devices 54 and/or input-output devices 28 may include input devices for gathering user input and/or making environmental measurements and may include output devices for providing a user with output.

As examples, input-output devices 28 and/or input-output devices 54 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 54 may also include sensors for gathering input from a user and/or for making measurements of the surroundings of WPT system 8.

The example in FIG. 1 of PRX device 24 including battery 34 is merely illustrative. If desired, an electronic device may include a supercapacitor to store charge instead of a battery. For example, PRX device 24 may include a supercapacitor in place of battery 34. Battery 34 may therefore sometimes be referred to as power storage device 34 or supercapacitor 34.

PTX device 12 and PRX device 24 may communicate wirelessly using in-band or out-of-band communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. When PTX 12 sends in-band data to PRX 24, wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. When PRX 24 sends in-band data to PTX 12, wireless transceiver (TX/RX) circuitry 40 may modulate wireless charging signal 44 to impart FSK or ASK communications, and wireless transceiver circuitry 20 may demodulate the wireless charging signal 44 to obtain the data that is being communicated.

Implementations using out-of-band communication may utilize, for example, hardware antenna structures and communication protocols such as Bluetooth or NFC to communicate out-of-band data between PTX device 12 and PRX device 24. Power may be conveyed wirelessly between coils 32 and 48 concurrently with the out-of-band data transmissions. Wireless transceiver circuitry 20 may wirelessly transmit and/or receive out-of-band signals to and/or from PRX device 24 using an antenna such as antenna 56. Wireless transceiver circuitry 40 may wirelessly transmit and/or receive out-of-band signals to and/or from PTX device 12 using an antenna such as antenna 58.

Control circuitry 16 in PTX device 12 has measurement circuitry 18 that may be used to perform measurements of one or more characteristics external to PTX device 12. For example, measurement circuitry 18 may detect external objects on or adjacent the charging surface of the housing of PTX device 12. While shown in FIG. 1 as being separate from power transmitting circuitry 22 for the sake of clarity, measurement circuitry 18 may form a part of power transmitting circuitry 22 if desired.

Measurement circuitry 18 may detect foreign objects such as coils, paper clips, and other metallic objects, may detect the presence of PRX device 24 (e.g., circuitry 18 may detect the presence of one or more coils 48 and/or magnetic core material associated with coils 48), and/or may detect the presence of other power transmitting devices in the vicinity of PTX device 12 and/or WPT system 8. Measurement circuitry 18 may also be used to make sensor measurements using a capacitive sensor, may be used to make temperature measurements, and/or may otherwise be used in gathering information indicative of whether a foreign object, power transmitting device, power receiving device, or other external object (e.g., PRX device 24) is present on or adjacent to the coil(s) 32 of PTX device 12. If desired, PRX device 24 may include measurement circuitry 42. Measurement circuitry 42 may perform one or more of the measurements performed by measurement circuitry 18 (e.g., for or using coil(s) 48 on PRX device 24).

Each one of housing 30 and housing 52 may be formed from plastic, metal, fiber-composite materials such as carbon-fiber materials, wood and other natural materials, glass, other materials, and/or combinations of two or more of these materials.

The example in FIG. 1 of PTX 12 transmitting wireless power and PRX 24 receiving wireless power is merely illustrative. PTX 12 may optionally be capable of receiving wireless power signals using coil(s) 32 and PRX 24 may optionally be capable of transmitting wireless power signals using coil(s) 48. When a device is capable of both transmitting and receiving wireless power signals, the device may include both an inverter and a rectifier.

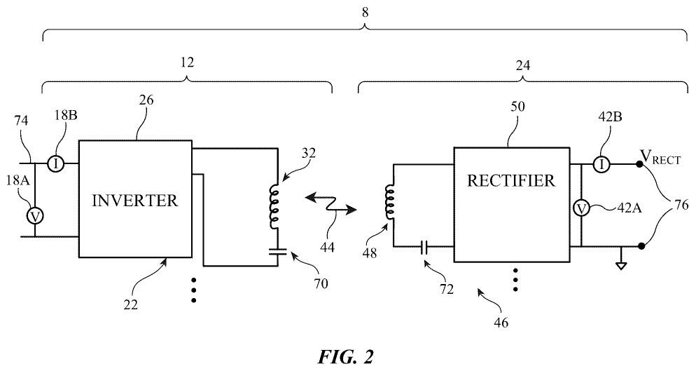

FIG. 2 is a circuit diagram of illustrative wireless charging circuitry for system 8. As shown in FIG. 2, circuitry 22 may include inverter circuitry such as one or more inverters 26 or other drive circuitry that produces wireless power signals that are transmitted through an output circuit that includes one or more coils 32 and capacitors such as capacitor 70. In some embodiments, device 12 may include multiple individually controlled inverters 26, each of which supplies drive signals to a respective coil 32. In other embodiments, an inverter 26 is shared between multiple coils 32 using switching circuitry.

During operation, control signals for inverter(s) 26 are provided by control circuitry 16 at one or more control inputs 74. A single inverter 26 and single coil 32 is shown in the example of FIG. 2, but multiple inverters 26 and multiple coils 32 may be used, if desired. In a multiple coil configuration, switching circuitry (e.g., multiplexer circuitry) may be used to couple a single inverter 26 to multiple coils 32 and/or each coil 32 may be coupled to a respective inverter 26. During wireless power transmission operations, transistors in one or more selected inverters 26 are driven by AC control signals from control circuitry 16. The relative phase between the inverters may be adjusted dynamically (e.g., a pair of inverters 26 may produce output signals in phase or out of phase).

The application of drive signals using inverter(s) 26 (e.g., transistors or other switches in circuitry 22) causes the output circuits formed from selected coils 32 and capacitors 70 to produce alternating-current electromagnetic fields (signals 44) that are received by wireless power receiving circuitry 46 using a wireless power receiving circuit formed from one or more coils 48 and one or more capacitors 72 in device 24.

Rectifier circuitry 50 is coupled to one or more coils 48 and converts received power from AC to DC and supplies a corresponding direct current output voltage V_{rect} across rectifier output terminals 76 for powering load circuitry in device 24 (e.g., for charging battery 34, for powering a display and/or other input-output devices 54, and/or for powering other components).

FIG. 2 shows how measurement circuitry 18 within PTX 12 may include one or more voltage sensors such as voltage sensor 18A and one or more current sensors such as current sensor 18B. Additionally, measurement circuitry 42 within PRX 24 may include one or more voltage sensors such as voltage sensor 42A and one or more current sensors such as current sensor 42B. The voltage and current sensors within system 8 may be used to determine power levels within the system.

The specific locations of sensors 18A, 18B, 42A, and 42B (on the DC sides of inverter 26 and rectifier 50 respectively) in FIG. 2 are merely illustrative. In general, voltage and current sensors may be positioned at any desired positions within the power transmitting circuitry 22 and the power receiving circuitry 46 (e.g., on the AC sides of inverter 26 and rectifier 50 if desired).

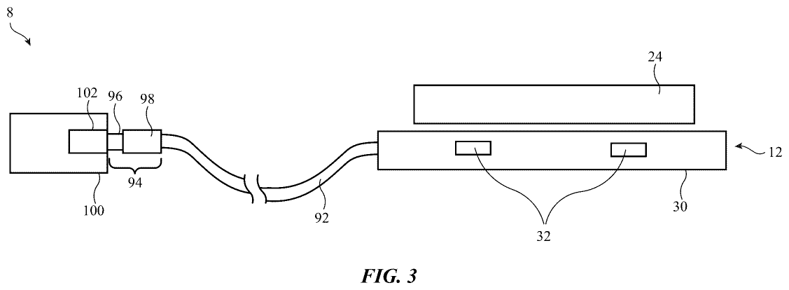

FIG. 3 is a cross-sectional side view of system 8 in an illustrative configuration in which wireless power transmitting device 12 is a wireless charging puck and in which wireless power receiving device 24 is a wristwatch, as an example. As shown in FIG. 3, device 12 has a device housing 30 (e.g., a disk-shaped puck housing formed form polymer, other dielectric material, and/or other materials). Device housing 30 may house a device microcontroller for communicating with plug 94, DC-DC power converter circuitry such as a step-down voltage converter (e.g., a buck converter), voltage regulator circuitry such as a low-dropout (LDO) regulator, wireless power transmitting circuitry such as inverter 26 (see FIG. 2), coil(s) 32, capacitor 70, near-field communications (NFC) circuitry for communicating with power receiving device 24, over-temperature protection (OTP) circuitry such as a temperature sensor, debug circuitry, filter circuitry, magnetic alignment structures such as magnets for attracting device 24 during charging operations, and/or other power transmitting device components.

Cable 92 is coupled to device housing 30 and provides power to coil(s) 32. One end of cable 92 may be pigtailed to housing 30. The opposing end of cable 92 is terminated using plug 94. Plug 94 has a boot portion 98 sometimes referred to as the “boot” of the plug. Cable 92 and plug 94 may be considered part of PTX 12 or may be considered a separate component from PTX 12. Boot 98, which may sometimes be referred to as a connector boot, may be formed from polymer, metal, and/or other materials and may have an interior region configured to house electrical components (e.g., integrated circuits, discrete components such as transistors, printed circuits, etc.). Boot 98 has a first end connected to cable 92 and a second end connected to a connector portion 96 (sometimes referred to as the “connector” of the plug). Connector 96 may include 24 pins, 10-30 pins, 10 or more pins, 20 or more pins, 30 or more pins, 40 or more pins, 50 or more pins, or any suitable number of pins supported within a connector housing. The pins within connector 96 are configured to mate with corresponding pins in port 102 of external equipment such as device 100. Device 100 may be a stand-alone power adapter that converts alternating-current (AC) power to direct-current (DC) power, an electronic device such as a computer, or other equipment that provides DC power to plug 94 through port 102. Port 102 may be, for example, a USB port (e.g., a USB type-C port, a USB 4.0 port, a USB 3.0 port, a USB 2.0 port, a micro-USB port, etc.) or a Lightning connector port. Plug 96 having a connector protruding from boot 98 may be referred to as a male plug. Plug 96 may be a reversible plug (i.e., a plug that may be mated with a corresponding connector port in at least two different and symmetrical orientations).

During operation of system 8, power receiving device 24 may be placed on the charging surface of power transmitting device 12. Device 24 and device 12 may have magnets (and/or magnetic material such as iron). For example, device 24 may have a magnet and device 12 may have a corresponding mating magnet. These magnets attract each other and thereby hold devices 12 and 24 together during charging.

Boot 98 may have a boot housing that houses various electrical components. The boot housing may house a boot microcontroller for communicating with the device microcontroller in housing 30, DC-DC power converter circuitry such as a step-up voltage converter (e.g., a boost converter), voltage regulator circuitry such as a low-dropout (LDO) regulator, electronic fuse circuitry such as an e-fuse or fuse for providing overcurrent protection when detecting short circuits, overloading, mismatched loads, or other device failure events, filter circuitry, and/or other boot components. In one illustrative arrangement, inverter 26 may be formed in boot 98 instead of in housing 30.

During wireless power transfer operations, it may be desirable to optimize the efficiency of wireless power transfer between PTX 12 and PRX 24. To help optimize efficiency, PTX 12 may report efficiency information to PRX 24. The efficiency information may be transmitted by PTX 12 to PRX 24 using in-band communication (e.g., using coils 32 and 48) or using out-of-band communication (e.g., using antennas 56 and 58). PRX 24 may request the efficiency information form PTX 12. After receiving the efficiency information, PRX 24 may change a wireless power transfer parameter based on the received efficiency information to attempt to improve an efficiency within the wireless power system.

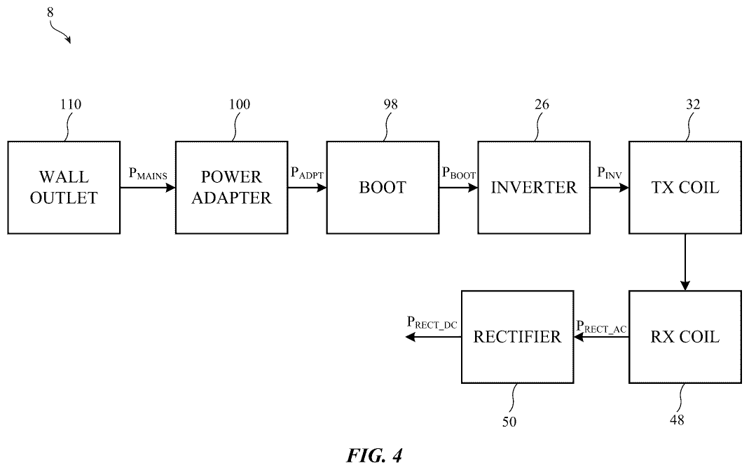

FIG. 4 shows the transfer of power through system 8. A power adapter 100 (such as the power adapter of FIG. 3) may receive power from a power source such as wall outlet 110. Wall outlet 110 may provide AC power at a first level P_{MAINS}. Power adapter 100 may convert the received AC power to DC power. The DC power output from power adapter may have a second level P_{ADPT}. A plug including boot portion 98 may be coupled to power adapter 100. Boot portion 98 may include power conversion circuitry that outputs DC power with a third level P_{BOOT}. The power output from boot portion 98 may be provided to inverter 26 within housing 30 (e.g., using cable 92 and/or other circuitry within power transmitting device 12). Inverter 26 uses the input power P_{BOOT} to create AC current signals through wireless power transmitting coil 32. The AC signals generated by inverter 26 and provided to transmitting (TX) coil 32 may have a fourth power level P_{INV}.

As the AC currents pass through one or more coils 32, alternating-current electromagnetic (e.g., magnetic) fields (wireless power signals 44) are produced that are received by one or more corresponding receiver coils such as coil(s) 48 in PRX device 24. The signals received at RX coil 48 may have a fifth power level P_{RECT_AC}. Rectifier 50 converts the AC power received at RX coil 48 to DC power at a sixth level P_{RECT_DC}.

There may be power inefficiency associated with each stage of the transfer of power through system 8. In other words, power adapter 100 has an associated power conversion and/or consumption inefficiency that causes P_{ADPT} to be less than P_{MAINS}, boot portion 98 has an associated power inefficiency that causes P_{BOOT} to be less than P_{ADPT}, inverter 26 has an associated power inefficiency that causes P_{INV} to be less than P_{BOOT}, wireless power transfer between TX coil 32 and RX coil 48 has an associated power inefficiency that causes P_{RECT_AC} to be less than P_{INV}, and rectifier 50 has an associated power inefficiency that causes P_{RECT_DC} to be less than P_{RECT_AC} (e.g., P_{MAINS}>P_{ADPT}>P_{BOOT}>P_{INV}>P_{RECT_AC}>P_{RECT_DC}).

In view of the varying power levels within wireless power system 8, there are many ways to characterize efficiency within the wireless power system. In general, efficiency may refer to a ratio of two power levels within the system, with the numerator's power level further downstream in the power transfer (and therefore lower) than the denominator's power level.

Efficiency of the wireless power transfer between PTX 12 and PRX 24 may be characterized by a ratio of at least one power level within PRX 24 and at least one power level within PTX 12 or power adapter 100. For example, the efficiency of wireless power transfer between PTX 12 and PRX 24 may be characterized as the ratio of P_{RECT_DC} and P_{INV} (e.g., E_{TRANSFER}=P_{RECT_DC}/P_{INV}).

An operating efficiency of PTX 12 may be characterized by a ratio of two power levels within PTX 12 or power adapter 100. For example, the operating efficiency of PTX 12 may be characterized as the ratio of P_{INV} and P_{ADPT} (e.g., E_{PTX}=P_{INV}/P_{ADPT}) or as the ratio of P_{INV} and P_{BOOT} (e.g., E_{PTX}=P_{INV}/P_{BOOT}).

During wireless power transfer operations, PTX 12 may report efficiency information to PRX 24. The efficiency information may include efficiency information associated with the wireless power transfer (e.g., E_{TRANSFER}=P_{RECT_DC}/P_{INV}) and/or an operating efficiency of PTX 12 (e.g., E_{PTX}=P_{INV}/P_{ADPT}). In some cases, the efficiency may be determined by PTX 12 and reported directly to PRX 24. In other cases, PTX 12 may transmit information (e.g., power level information, current information, and/or voltage information) to PRX 24 that PRX 24 subsequently uses to derive an efficiency.

As one example, PTX 12 may determine P_{INV} (e.g., using current and/or voltage measurements). PTX 12 may report P_{INV} to PRX 24 and PRX 24 subsequently determines efficiency E_{TRANSFER} using the received P_{INV} and an internally determined P_{RECT_DC}. Alternatively, PTX 12 may receive information on P_{RECT_DC} from PRX 24, determine E_{TRANSFER} using P_{INV} and P_{RECT_DC}, and report E_{TRANSFER} to PRX 24.

Power is a function of current and voltage. The power at a given point within system 8 may therefore be determined using current information and/or voltage information at the given point within system 8. To obtain current information and/or voltage information to calculate a power level, measurement circuitry within each electronic device may include current sensors and/or voltage sensors. FIG. 2 shows how PTX 12 may include voltage sensor 18A and/or current sensor 18B. Information from these sensors may be used to determine the power level P_{INV} of inverter 26. FIG. 2 shows how PRX 24 may include voltage sensor 42A and/or current sensor 42B. Information from these sensors may be used to determine the power level P_{RECT_DC} of rectifier 50.

In general, current and/or voltage sensors at any desired locations within system 8 (e.g., within power adapter 100, within boot 98, within inverter 26, and/or within rectifier 50) may be used to determine current information and/or voltage information at a desired location within system 8. The current information and/or voltage information may then be used to determine a power level associated with the desired location within the system.

When reporting efficiency information to PRX 24, PTX 12 may report proxy information for power levels within system 8. The proxy information may include current information and/or voltage information. As examples, PTX 12 may report efficiency information that includes a voltage V_{INV} associated with inverter 26 (e.g., a voltage measured by voltage sensor 18A) and/or a current I_{INV} associated with inverter 26 (e.g., a current measured by current sensor 18B). PRX 24 may use the proxy information V_{INV} and/or I_{INV} to determine P_{INV} and then determine the efficiency of the wireless power transfer using P_{INV}.

It should be noted that the magnitudes of efficiency levels, power levels, current levels, and/or voltage levels reported by PTX 12 may be averaged over a time period. The duration of the time period may be predetermined and/or may be adjusted in real time.

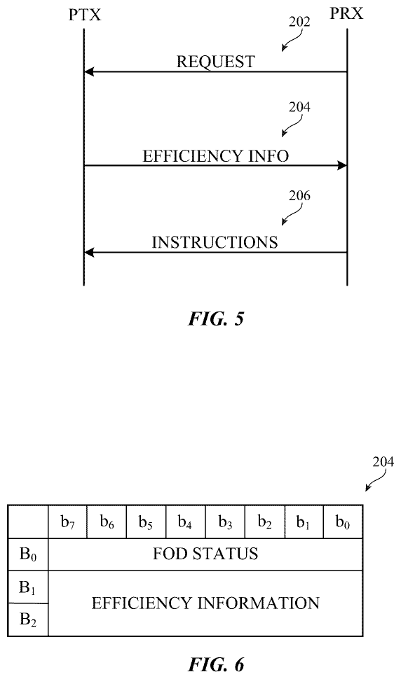

FIG. 5 is a flowchart showing how PTX 12 may report efficiency information to PRX 24. As shown in FIG. 5, PRX 24 may first transmit a request packet 202 to PTX 12. The request packet 202 may include, for example, received power information associated with PRX 24. The received power information may include P_{RECT_DC}, as one example.

PTX 12 may be configured to treat packet 202 (with the received power information) as a request for efficiency information. After receiving request packet 202, PTX may subsequently transmit an efficiency information packet 204 to PRX 24. The efficiency information packet 204 may include an efficiency level (e.g., E_{TRANSFER}), power information (P_{INV}), and/or proxy information (e.g., I_{INV} or V_{INV}) that may be used by PRX 24 to determine a power level and/or efficiency. The exact type or types of information that a PTX transmits to a PRX under a given usage condition may be based on agreement between the PTX and PRX, such as operating parameters that are agreed upon between the devices during digital handshaking.

After receiving the efficiency information, PRX 24 may optionally send instructions packet(s) 206 to PTX 12. The instructions packet 206 may include an instruction to update a wireless power transfer parameter associated with PTX 12. For example, the instructions may include instructions to update the target magnitude of P_{INV}.

The transmissions of packets 202, 204, and 206 shown in FIG. 5 may be performed using in-band communications and/or out-of-band communications. In one illustrative example, in-band communications are used for the transmission of packets 202, 204, and 206.

Transceiver circuitry 40 may perform ASK modulation on signals 44 to transmit request packet 202 from PRX 24 to PTX 12 (e.g., from coil 48 to coil 32) while PRX 24 receives wireless power from PTX 12. Transceiver circuitry 20 may perform ASK demodulation to receive packet 202 from PRX 24 while PTX 12 transmits wireless power to PRX 24.

Transceiver circuitry 20 may perform FSK modulation on signals 44 to transmit efficiency information packet 204 from PTX 12 to PRX 24 (e.g., from coil 32 to coil 48) while PTX 12 transmits wireless power to PRX 24. Transceiver circuitry 40 may perform FSK demodulation to receive packet 204 from PTX 12 while PRX 24 receives wireless power from PTX 12.

Transceiver circuitry 40 may perform ASK modulation on signals 44 to transmit instructions packet 206 from PRX 24 to PTX 12 (e.g., from coil 48 to coil 32) while PRX 24 receives wireless power from PTX 12. Transceiver circuitry 20 may perform ASK demodulation to receive packet 206 from PRX 24 while PTX 12 transmits wireless power to PRX 24.

In another illustrative example, out-of-band communications may be used for the transmission of packets 202, 204, and 206. For example, transceiver circuitry 40 may use antenna 58 to transmit request packet 202 from PRX 24 to PTX 12 (e.g., using Bluetooth or NFC communications). Transceiver circuitry 20 may receive packet 202 from PRX 24 using antenna 56. Transceiver circuitry 20 may use antenna 56 to transmit efficiency information packet 204 from PTX 12 to PRX 24 (e.g., using Bluetooth or NFC communications). Transceiver circuitry 40 may receive packet 204 from PTX 12 using antenna 58. Transceiver circuitry 40 may use antenna 58 to transmit instructions packet 206 from PRX 24 to PTX 12 (e.g., using Bluetooth or NFC communications). Transceiver circuitry 20 may receive packet 206 from PRX 24 using antenna 56.

Packet 202 may sometimes be referred to as a power loss accounting (PLA) packet or received power (RP) packet. The packet may include received power information (e.g., P_{RECT_DC}). The received power information included in packet 202 may be used by PTX 12 for foreign object detection (FOD) operations. During FOD operations, PTX 12 may perform power loss accounting. During power loss accounting, PTX 12 uses the received power information (from packet 202) and transmitted power information (as measured by circuitry 18) to estimate the amount of power loss caused by a foreign object in the vicinity of PTX 12 and/or PRX 24. If the estimated power loss caused by the foreign object is greater than a threshold, the PTX 12 may instruct PRX 24 to reduce its power consumption (e.g., reduce P_{RECT_DC}), may reduce the transmitted power level (e.g., P_{INV}), and/or may abort the power transfer.

Each time PTX 12 receives packet 202 (e.g., a power loss accounting packet), PTX 12 may determine an FOD status and report the FOD status to PRX 24. Additionally, each time PTX 12 receives packet 202, PTX 12 may report efficiency information to PRX 24.

Each one of packets 202, 204, and 206 may include numerous data bits (sometimes referred to as bits). The data bits may be grouped into bytes, with each byte including any desired number of bits (e.g., 8 bits).

FIG. 6 shows a packet structure for packet 204 that includes efficiency information. As shown, packet 204 may include a portion, such as a first byte, that includes FOD status information. The FOD status information may include one of several possible statuses. As examples, a first FOD status may indicate that no foreign object is present, a second FOD status may indicate that a foreign object has been detected, and a third FOD status may indicate that the FOD detection is inconclusive (e.g., an FOD may or may not be present). The second and third FOD statuses may cause PRX 24 to reduce wireless power levels and/or forgo (e.g., stop or pause) the wireless power transfer operation.

In addition to the FOD status information, packet 204 may include another portion, such as one or more bytes of payload, that include efficiency information. As previously mentioned, the efficiency information may include efficiency levels, power levels, and/or power level proxy information such as current and/or voltage levels. One or more bits in the efficiency information may identify the type of efficiency information included. For example, one or more bits may identify that a power transfer efficiency value (E_{TRANFER}) is the type of efficiency information included and one or more bits may represent the magnitude of the power transfer efficiency value.

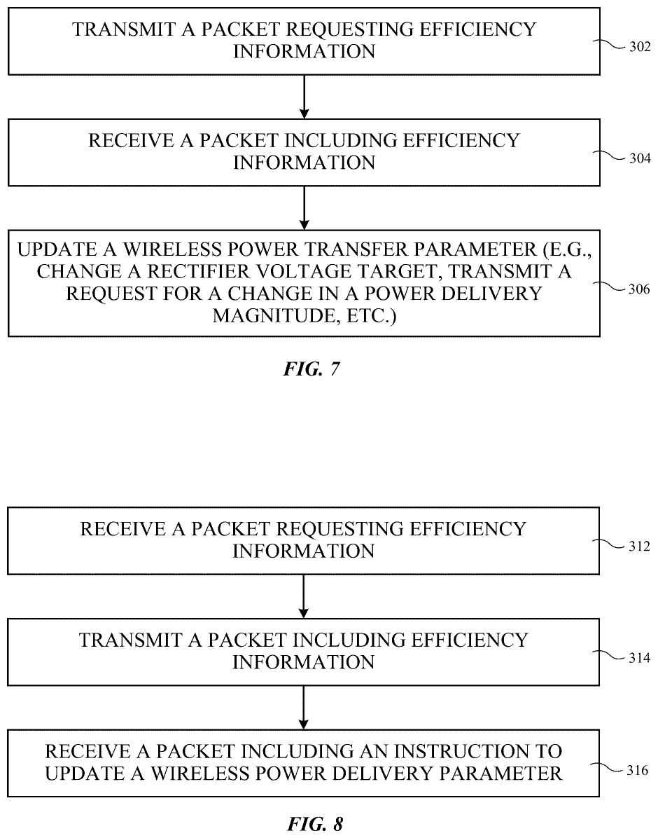

FIG. 7 is a flowchart of an illustrative method that may be performed by PRX 24 (e.g., control circuitry 38 in PRX 24). During the operations of block 302, PRX 24 may transmit a packet requesting efficiency information. The packet may be transmitted using in-band communication (e.g., FSK or ASK modulation) or using out-of-band communication using antenna 58 (e.g., Bluetooth or NFC communication). The packet transmitted during the operations of block 302 may be a power loss accounting (PLA) packet or received power (RP) packet that includes received power information. The received power information may be determined using current and/or voltage sensors such as current sensor 42B and voltage sensor 42A in FIG. 2.

After transmitting the packet requesting efficiency information at block 302, PRX 24 may receive a packet including efficiency information at block 304. The packet may be received using in-band communication (e.g., FSK or ASK demodulation) or using out-of-band communication using antenna 58 (e.g., Bluetooth or NFC communication).

The efficiency information included in the packet at block 304 may include a wireless power transfer efficiency that is a ratio of a power level associated with PRX 24 to a power level associated with PTX 12 (e.g., E_{TRANSFER} as previously discussed). The efficiency information included in the packet at block 304 may include a PTX operating efficiency that is a ratio of two power levels associated with PTX 12 (e.g., E_{PTX} as previously discussed).

In some cases, the efficiency information included in the packet at block 304 may include a power level. PRX 24 may use the power level to determine a wireless power transfer efficiency that is a ratio of a power level associated with PRX 24 to a power level associated with PTX 12 (e.g., E_{TRANSFER} as previously discussed).

In some cases, the efficiency information included in the packet at block 304 may include a voltage level and/or a current level associated with PTX 12 (e.g., I_{INV} or V_{INV}). PRX 24 may use this information to determine a power level associated with PTX 12. The power level associated with PTX 12 may then be used to determine a wireless power transfer efficiency (e.g., E_{TRANSFER}).

Next, during the operations of block 306, PRX 24 may update a wireless power transfer parameter based on the efficiency information received at block 304. There are a variety of suitable wireless power transfer parameters that may be updated at block 306.

One driver of efficiency in wireless power transfer operations is the voltage of rectifier 50 (e.g., V_{RECT} in FIG. 2). For a given set of wireless power transfer operating conditions, there may be a V_{RECT} that produces an optimal efficiency E_{TRANSFER}. The value of V_{RECT} that produces the optimal efficiency E_{TRANSFER} may be referred to as the optimal V_{RECT} Or V_{RECT_OPT}. The magnitude of V_{RECT_OPT} may drift over time (e.g., as the state of charge of battery 34 in PRX 24 changes). The target magnitude of V_{RECT} may therefore be continuously tuned based on efficiency information reported from PTX 12 to optimize efficiency as V_{RECT_OPT} drifts over time.

During wireless power transfer, PRX may update the target value of V_{RECT} and subsequently receive efficiency information via packet 204. If changing the value of V_{RECT} increased efficiency (as determined using the received efficiency information), V_{RECT} may be incremented in the same direction that caused the increase in efficiency. If changing the value of V_{RECT} decreased efficiency (as determined using the received efficiency information), V_{RECT} may be incremented in the opposite direction that caused the increase in efficiency. This process may be repeated to optimize efficiency as V_{RECT_OPT} drifts over time.

Consider a PRX 24 that has an initial target V_{RECT} of V_{RECT_1} at t₁. The magnitude of E_{TRANSFER} associated with V_{RECT1} is E_{TRANSFER1} and may be determined using the efficiency information received at block 304. At a subsequent time t₂, the target magnitude of V_{RECT} may be incremented by +0.1V to V_{RECT2}. PRX 24 may then request efficiency information and receive efficiency information indicating that the magnitude of E_{TRANSFER} associated with V_{RECT2} is E_{TRANSFER2}. When E_{TRANSFER2} is greater than E_{TRANSFER1}, it is indicative that the change in V_{RECT} from V_{RECT1} to V_{RECT2} improved efficiency. When E_{TRANSFER2} is less than E_{TRANSFER1}, it is indicative that the change in V_{RECT} from V_{RECT1} to V_{RECT2} decreased efficiency. When E_{TRANSFER2} is greater than E_{TRANSFER1}, the target magnitude of V_{RECT} may be incremented by another +0.1V during the next iteration of V_{RECT} optimization. When E_{TRANSFER2} is less than E_{TRANSFER1}, the target magnitude of V_{RECT} may be incremented by −0.1V (e.g., the magnitude of the increment is the same but the sign is reversed) during the next iteration of V_{RECT} optimization. This process may be continuously repeated by PRX 24 to optimize the efficiency of one or more aspects of wireless power transfer over the entire wireless charging time.

V_{RECT} may be updated at any desired frequency (e.g., more than once per second, more than once every 10 seconds, more than once every thirty seconds, etc.). PRX 24 may transmit packet 202 and receive packet 204 at the same frequency that V_{RECT} is updated (e.g., more than once per second, more than once every 10 seconds, more than once every thirty seconds, etc.).

The example of updating V_{RECT} during the operations of block 306 is merely illustrative. As another example, PRX 24 may update a target power delivery magnitude at block 306. In some conditions, PTX 12 may operate at a maximum power level to minimize the total charging time of PRX 24. However, the efficiency of the wireless power transfer may sometimes be higher at lower power levels than at the maximum power level. In some conditions, PRX 24 may choose to prioritize maximizing power transfer efficiency over minimizing charging time. In these situations, PRX 24 may iteratively adjust the target power delivery magnitude and subsequently receive efficiency information to identify a target power delivery magnitude with an optimal efficiency. PRX 24 may adjust the target power delivery magnitude at block 306 by transmitting an instruction packet 206 to PTX 12 that instructs PTX 12 to change the target power delivery magnitude.

One condition in which maximizing power transfer efficiency may be prioritized over minimizing charging time is when a user charges their device overnight. In this scenario, PRX 24 may aim to fully charge PRX 24 by the next morning (not necessarily as fast as possible). PRX 24 may therefore lower the target power delivery magnitude to improve efficiency in this scenario.

PRX 24 may send an instruction to PTX 12 at block 306 instructing PTX 12 to update another desired wireless power transfer parameter. PTX 12 may update a wireless power transfer parameter associated with adapter 100, boot portion 98, and/or inverter 26. Updating the wireless power transfer parameter in PTX 12 may improve the power transfer efficiency and/or an operating efficiency associated with PTX 12.

FIG. 8 is a flowchart of an illustrative method that may be performed by PTX 12 (e.g., control circuitry 16 in PTX 12). During the operations of block 312, PTX 12 may receive a packet requesting efficiency information. The packet may be received using in-band communication (e.g., FSK or ASK demodulation) or using out-of-band communication using antenna 56 (e.g., Bluetooth or NFC communication). The packet received during the operations of block 312 may be a power loss accounting (PLA) packet or received power (RP) packet that includes received power information.

After receiving the packet requesting efficiency information at block 312, PTX 12 may transmit a packet including efficiency information at block 314. The packet may be transmitted using in-band communication (e.g., FSK or ASK modulation) or using out-of-band communication using antenna 56 (e.g., Bluetooth or NFC communication).

The efficiency information included in the packet at block 314 may include a wireless power transfer efficiency that is a ratio of a power level associated with PRX 24 to a power level associated with PTX 12 (e.g., E_{TRANSFER} as previously discussed). The efficiency information included in the packet at block 314 may include a PTX operating efficiency that is a ratio of two power levels associated with PTX 12 (e.g., E_{PTX} as previously discussed).

In some cases, the efficiency information included in the packet at block 314 may include a power level. PRX 24 may use the power level to determine a wireless power transfer efficiency that is a ratio of a power level associated with PRX 24 to a power level associated with PTX 12 (e.g., E_{TRANSFER} as previously discussed).

In some cases, the efficiency information included in the packet at block 314 may include a voltage level and/or a current level associated with PTX 12 (e.g., I_{INV} or V_{INV}). PRX 24 may use this information to determine a power level associated with PTX 12. The power level associated with PTX 12 may then be used to determine an efficiency (e.g., E_{TRANSFER}).

Next, during the operations of block 316, PTX 12 may receive a packet including an instruction to update a wireless power delivery parameter. The packet may be received using in-band communication (e.g., FSK or ASK demodulation) or using out-of-band communication using antenna 56 (e.g., Bluetooth or NFC communication).

The wireless power delivery parameter updated by the instruction at block 316 may include any parameter associated with adapter 100, boot 98, and/or inverter 26. As one example, the wireless power delivery parameter updated by the instruction may be a target power output for inverter 26.

It is noted that receiving the packet requesting efficiency information at block 312 may also prompt PTX 12 to perform an FOD operation. The FOD status determined by the FOD operation may be included in the packet transmitted at block 314.

The foregoing is merely illustrative and various modifications can be made to the described embodiments. The foregoing embodiments may be implemented individually or in any combination.

What is claimed is:

1. A system comprising:
a wireless power transmitting device comprising:
a first wireless power transfer coil configured to transmit wireless power signals;
an inverter that is configured to drive the first wireless power transfer coil; and
first control circuitry configured to:
receive a first packet; and
in accordance with receiving the first packet, transmit a second packet that comprises efficiency information, wherein the efficiency information comprises information selected from the group consisting of: an operating efficiency of the wireless power transmitting device, a ratio of a first power received by the wireless power receiving device to a second power output from the wireless power transmitting device, a voltage for the inverter, a current for the inverter, and a power for the inverter; and
a wireless power receiving device comprising:
a second wireless power transfer coil configured to receive the wireless power signals from the first wireless power transfer coil; and
second control circuitry configured to:
transmit the first packet;
after transmitting the first packet, receive the second packet;
determine a wireless power transfer efficiency using the efficiency information in the second packet; and
in accordance with receiving the second packet, update a wireless power transfer parameter based on the determined wireless power transfer efficiency.

2. An electronic device comprising:
a wireless power transfer coil;
a rectifier that is connected to the wireless power transfer coil; and
control circuitry configured to:
transmit a first packet to an additional electronic device;
after transmitting the first packet, receive a second packet from the additional electronic device that includes efficiency information; and
in accordance with receiving the second packet, update a wireless power transfer parameter.

3. The electronic device of claim 2, wherein updating the wireless power transfer parameter comprises changing a rectifier voltage target of the rectifier.

4. The electronic device of claim 2, wherein updating the wireless power transfer parameter comprises using the control circuitry to transmit an instruction and wherein the instruction comprises a request for a change in a target power delivery magnitude.

5. The electronic device of claim 2, wherein the first packet is a power loss accounting (PLA) packet.

6. The electronic device of claim 2, wherein the first packet is a received power (RP) packet.

7. The electronic device of claim 2, wherein the efficiency information comprises an operating efficiency of a wireless power transmitting device.

8. The electronic device of claim 2, wherein the efficiency information comprises a ratio of a first power received by the electronic device to a second power output from the additional electronic device.

9. The electronic device of claim 2, wherein the efficiency information comprises an inverter voltage.

10. The electronic device of claim 2, wherein the efficiency information comprises an inverter current.

11. The electronic device of claim 2, wherein the efficiency information comprises an inverter power.

12. The electronic device of claim 2, wherein transmitting the first packet comprises transmitting the first packet using the wireless power transfer coil and wherein receiving the second packet comprises receiving the second packet using the wireless power transfer coil.

13. An electronic device comprising:
a wireless power transfer coil;
an inverter that is configured to supply alternating-current drive signals to the wireless power transfer coil; and
control circuitry configured to:
receive a first packet from an additional electronic device; and
in accordance with receiving the first packet, transmit a second packet to the additional electronic device that comprises efficiency information.

14. The electronic device of claim 13, wherein the control circuitry is further configured to receive an instruction from the additional electronic device after transmitting the second packet to the additional electronic device.

15. The electronic device of claim 14, wherein the instruction comprises a request for a change in a target power delivery magnitude.

16. The electronic device of claim 13, wherein the first packet is a power loss accounting (PLA) packet.

17. The electronic device of claim 13, wherein the efficiency information comprises an operating efficiency of the electronic device.

18. The electronic device of claim 13, wherein the efficiency information comprises a ratio of a first power received by the additional electronic device to a second power output from the electronic device.

19. The electronic device of claim 13, wherein the efficiency information comprises information selected from the group consisting of: a voltage of the inverter, a current of the inverter, and a power of the inverter.

20. The electronic device of claim 13, wherein the electronic device is configured to receive direct current power from a cable that is connected to a power adapter, wherein the cable has a boot portion, and wherein the efficiency information comprises efficiency information selected from the group consisting of: efficiency information associated with the power adapter and efficiency information associated with the boot portion.
